(19) United States
(12) Patent Application Publication
(10) Pub. No.: US 2026/0091452 A1
(43) Pub. Date: Apr. 2, 2026

(54) WELDING CHECK METHOD FOR SYSTEM MAIN RELAY

(71) Applicant: TOYOTA JIDOSHA KABUSHIKI KAISHA, Toyota-shi (JP)

(72) Inventor: Shilong XU, Toyota-shi (JP)

(73) Assignee: TOYOTA JIDOSHA KABUSHIKI KAISHA, Toyota-shi (JP)

(21) Appl. No.: 19/217,457

(22) Filed: May 23, 2025

(30) Foreign Application Priority Data
Oct. 1, 2024 (JP) 2024-171927

(51) Int. Cl. B23K 31/12; B60R 16/033

(52) U.S. Cl. CPC B23K 31/125; B60R 16/033

(57) ABSTRACT

A welding check method for a system main relay provided between a high-voltage battery and one or more auxiliary loads that are mounted on a vehicle, the method includes stopping electric power supply from the high-voltage battery to the auxiliary load after Ready-OFF of the vehicle, performing a welding check of the system main relay after the electric power supply to the auxiliary load is stopped, and starting the electric power supply from the high-voltage battery to the auxiliary load in response to a request from the auxiliary load in a case where the system main relay is not welded as a result of the welding check.

### CROSS-REFERENCE TO RELATED APPLICATION

This application claims priority to Japanese Patent Application No. 2024-171927 filed on Oct. 1, 2024. The disclosure of the above-identified application, including the specification, drawings, and claims, is incorporated by reference herein in its entirety.

### BACKGROUND

### 1. Technical Field

The present disclosure relates to a method of checking whether a system main relay provided between a high-voltage battery and one or more auxiliary loads that are mounted on a vehicle is welded.

### 2. Description of Related Art

Japanese Unexamined Patent Application Publication No. 2023-156719 (JP 2023-156719 A) discloses a method of supplying electric power from a high-voltage battery to a specific auxiliary load. In the method, when a main switch of a vehicle is turned off with a system main relay turned on and there is a specific auxiliary load (an auxiliary battery is a main electric power source) to be operated after the main switch is turned off, electric power is supplied from the high-voltage battery to the specific auxiliary load with the system main relay maintained in an on state.

### SUMMARY

on-board diagnostics (OBD) regulations, there is a requirement to check whether the system main relay is welded at a specified monitor rate.

In the technique described in JP 2023-156719 A, when there is a specific auxiliary load to be operated after the main switch is turned off, the system main relay is maintained in the on state. Therefore, the welding check of the system main relay cannot be performed. Therefore, as a measure to satisfy the requirement of the OBD regulations, forcibly stopping the electric power supply from the high-voltage battery to the specific auxiliary load after the main switch is turned off and performing the welding check of the system main relay may be considered.

However, while the electric power supply from the high-voltage battery to the specific auxiliary load is stopped, the electric power of the auxiliary battery is consumed solely by the operation of the specific auxiliary load. Therefore, there is a risk of the auxiliary battery being drained.

The present disclosure has been made in view of the above issue, and an object of the present disclosure is to provide a welding check method for a system main relay that is capable of suppressing the auxiliary battery from being drained in a case where the welding check of the system main relay is performed after the main switch of the vehicle is turned off.

In order to solve the above issue, an aspect of a technique of the present disclosure is a welding check method for a system main relay provided between a high-voltage battery and one or more auxiliary loads that are mounted on a vehicle. The method includes stopping electric power supply from the high-voltage battery to the auxiliary load after the vehicle is in a Ready-OFF state, performing a welding check of the system main relay after the electric power supply to the auxiliary load is stopped, and starting the electric power supply from the high-voltage battery to the auxiliary load in response to a request from the auxiliary load when the result of the welding check indicates that the system main relay is not welded.

With the welding check method for a system main relay according to the present disclosure, when the welding check of the system main relay is performed after the main switch of the vehicle is turned off, the drain in the auxiliary battery can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of a control unit and peripheral units thereof for realizing a welding check method for a system main relay according to an embodiment of the present disclosure;

FIG. 2A is a processing flowchart illustrating the welding check method for a system main relay according to the embodiment of the present disclosure;

FIG. 2B is a processing flowchart illustrating the welding check method for a system main relay according to the embodiment of the present disclosure;

FIG. 3 is an example of a timing chart in a case where a request for IGB-ON by other factors is present; and

FIG. 4 is an example of a timing chart in a case where the request for IGB-ON by other factors is not present.

### DETAILED DESCRIPTION OF EMBODIMENTS

A welding check method for a system main relay of the present disclosure is configured to promptly restart the electric power supply from the high-voltage battery to the auxiliary load after the welding check, in a case where electric power supply from a high-voltage battery to an auxiliary load is stopped after Ready-OFF of a vehicle to perform a welding check of a system main relay, with the stoppage regarded as temporary in principle. As a result, the drain of the auxiliary battery is suppressed.

Hereinafter, an embodiment of the present disclosure will be described in detail with reference to the drawings.

### EMBODIMENT

### Configuration

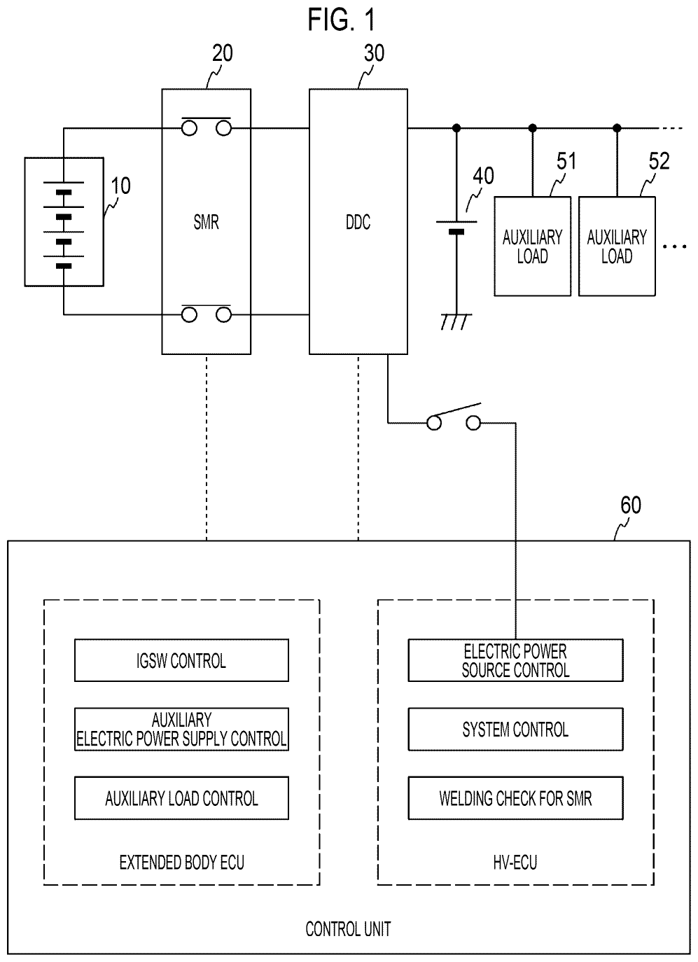

FIG. 1 is a functional block diagram of a control unit 60 and peripheral units thereof for realizing a welding check method for a system main relay according to an embodiment of the present disclosure. The functional blocks illustrated in FIG. 1 include a high-voltage battery 10, a system main relay (SMR) 20, a DCDC converter (DDC) 30, an auxiliary battery 40, a plurality of auxiliary loads 51, 52, and a control unit 60. In FIG. 1, a signal line for electric power is represented by a solid line, and a signal line for control/communication is represented by a dotted line, respectively.

The welding check method for a system main relay can be mounted on a vehicle, such as a hybrid electric vehicle (HEV), a plug-in hybrid electric vehicle (PHEV), and a battery electric vehicle (BEV) that use an electric motor as a power source.

The high-voltage battery 10 is a secondary battery configured to be chargeable and dischargeable, such as a lithium ion battery, and is a so-called drive battery that mainly supplies electric power to a starter motor, a traveling electric motor (not illustrated), and the like. The high-voltage battery 10 can supply electric power to the auxiliary loads 51, 52 via the system main relay 20 and the DCDC converter 30.

The system main relay 20 is a switching element for controlling a state of electric power exchange of the high-voltage battery 10, and is provided between the high-voltage battery 10 and the DCDC converter 30. Examples of the system main relay 20 include a mechanical relay having a movable terminal and a fixed terminal. The system main relay 20 can switch between a state in which the input and output terminals are electrically connected (relay ON) and a state in which the input and output terminals are electrically disconnected (relay OFF) based on an instruction from the control unit 60.

The DCDC converter 30 is an electric power converter that can convert input electric power into electric power of a predetermined voltage and output the electric power. The DCDC converter 30 has a first end connected to the high-voltage battery 10 via the system main relay 20 and a second end connected to the auxiliary battery 40, the auxiliary load 51, and the auxiliary load 52. The DCDC converter 30 can supply the electric power output from the high-voltage battery 10 which is connected to the first end to the auxiliary battery 40, the auxiliary load 51, and the auxiliary load 52 which are connected to the second end. The operation of the DCDC converter 30 is controlled by the control unit 60.

The auxiliary battery 40 is a secondary battery configured to be chargeable and dischargeable, such as a lead-acid battery or a lithium ion battery, and is a battery that supplies electric power to the auxiliary loads 51, 52. The auxiliary battery 40 is connected to the DCDC converter 30 such that the auxiliary battery 40 can be charged with the electric power of the high-voltage battery 10. In general, the rated voltage of the auxiliary battery 40 is set to be lower than the rated voltage of the high-voltage battery 10.

The auxiliary loads 51, 52 are devices or equipment that are mounted on the vehicle and consume electric power needed to execute a predetermined operation. The auxiliary loads 51, 52 include a specific auxiliary load (for example, an in-vehicle device such as a dashboard camera with a parking monitoring function) that consumes electric power in a state where the electric power supply system of the vehicle is stopped (Ready-OFF) such as during parking. The auxiliary loads 51, 52 are operated by the electric power supplied from the high-voltage battery 10 through the system main relay 20 and the DCDC converter 30 or the electric power stored in the auxiliary battery 40. In FIG. 1, an example in which two auxiliary loads 51, 52 are mounted on the vehicle is illustrated, but the number of auxiliary loads mounted on the vehicle is not limited thereto.

The control unit 60 is configured to control the electric power supply from the high-voltage battery 10 to the auxiliary battery 40, and the auxiliary loads 51, 52 by operating the ON/OFF operation of the system main relay 20. The control unit 60 includes at least each function of “IGSW control”, “auxiliary electric power supply control”, “auxiliary load control”, “electric power source control”, “system control”, and “welding check for SMR”. The “IGSW control” is control of an ON/OFF state of the IGB. The “auxiliary electric power supply control” is a control of supplying electric power to a specific auxiliary load when Ready-OFF is performed. The “auxiliary load control” controls the auxiliary loads 51, 52. The “electric power source control” is control of supplying the electric power for activation to the DCDC converter 30. The “system control” is control of the electric power supply from the high-voltage battery 10 to the auxiliary loads 51, 52 through the DCDC converter 30. The “welding check for SMR” is a determination of whether the movable terminal of the system main relay 20 and the fixed terminal are welded. These functions are communicably connected to a network, such as a controller area network (CAN).

A part or all of the control unit 60 can typically be configured by an electronic control unit (ECU) including a processor, a memory, an input and output interface, and the like, such as a microcomputer. As an example, each function of the IGSW control, the auxiliary electric power supply control, and the auxiliary load control can be included in the extended body ECU, and each function of the electric power source control, the system control, and the welding check for SMR can be included in the HV-ECU. The electronic control unit can realize a part or all of the above-described functions by the processor reading and executing the program stored in the memory.

### Control

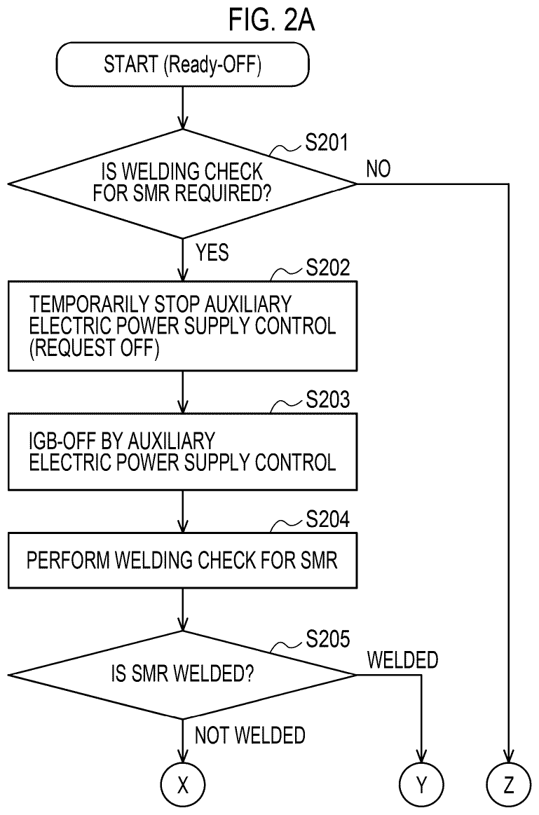

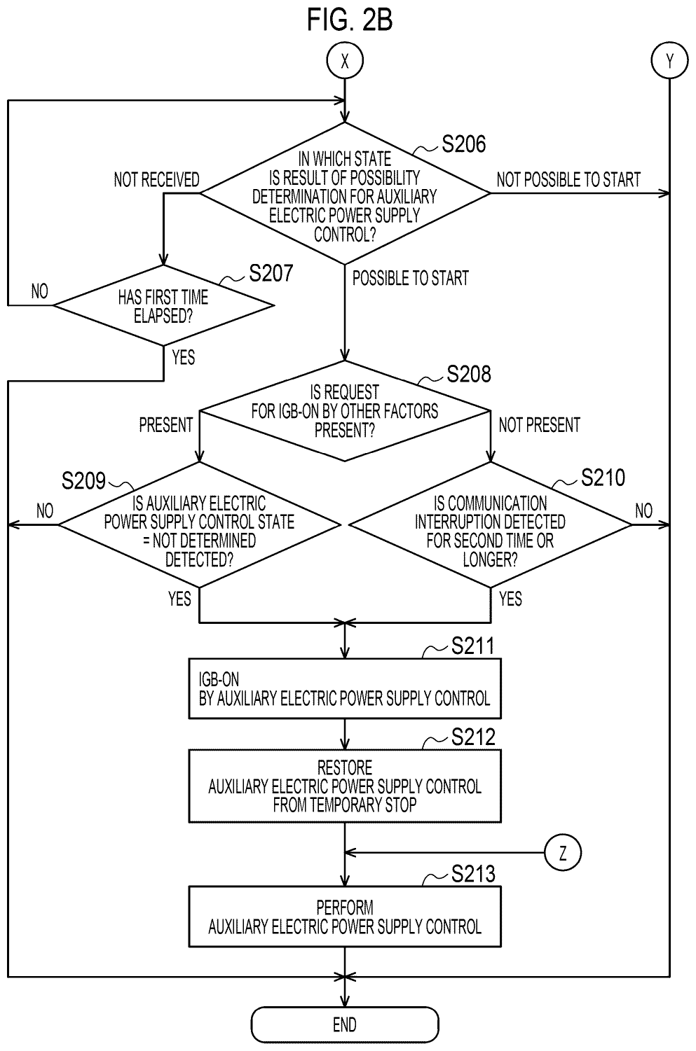

Next, the welding check method for a system main relay according to the present embodiment will be described with further reference to FIGS. 2A and 2B. FIGS. 2A and 2B are flowcharts illustrating a processing procedure of the welding check for SMR executed by the control unit 60. The process of FIG. 2A and the process of FIG. 2B are connected by connectors X, Y, Z, respectively.

The welding check for SMR illustrated in FIGS. 2A and 2B is started when the ignition switch is turned off and the vehicle is brought into the Ready-OFF state.

### S301

The control unit 60 determines whether the welding check of the system main relay 20 needs to be performed. The determination can be made, for example, by determining whether the state in which the welding check of the system main relay 20 cannot be performed due to the operation of the specific auxiliary load after the Ready-OFF of the vehicle continues for a predetermined period. The predetermined period is set based on the requirement obtained by the OBD regulations. Whether the welding check of the system main relay 20 is needed is determined by, for example, an HV-ECU (welding check for SMR function).

When the control unit 60 determines that the welding check of the system main relay 20 is required (S201, YES), the process proceeds to S202.

On the other hand, when the control unit 60 determines that the welding check of the system main relay 20 is not required (S201, NO), the process proceeds to S213.

### S302

The control unit 60 executes a process of temporarily stopping the auxiliary electric power supply control, in other words, a process of turning off the request for the auxiliary electric power supply control. As a specific example of the process, the HV-ECU (system control function) first transmits a signal requesting the “temporary stop of the state of the auxiliary electric power supply” to the extended body ECU (auxiliary electric power supply control function). Thereafter, the extended body ECU (auxiliary electric power supply control function) that receives the signal transmits a signal indicating “no request for auxiliary electric power supply control” to the HV-ECU (system control function). Further, a request for “IGB-OFF by auxiliary electric power supply control” is transmitted to the extended body ECU (IGSW control function). In addition, the extended body ECU is configured to prohibit the sleep of the CAN communication with the HV-ECU.

When the control unit 60 executes the process of temporarily stopping the auxiliary electric power supply control, the process proceeds to S203.

### S203

The control unit 60 executes the process of the IGB-OFF by the auxiliary electric power supply control. A specific example of the process is that the extended body ECU (IGSW control function) received the request of “IGB-OFF by the auxiliary electric power supply control” outputs the IGB-OFF signal to the HV-ECU (electric power source control function). By the process, the electric power source of the DCDC converter 30 is turned off, and the electric power supply from the high-voltage battery 10 to the auxiliary loads 51, 52 is stopped.

When the control unit 60 performs the process of the IGB-OFF by the auxiliary electric power supply control, the process proceeds to S204.

### S204

The control unit 60 executes a process of the welding check of the system main relay 20. The process is executed by the HV-ECU (welding check for SMR function). The welding check of the system main relay 20 can be performed using a well-known method, such as performing a voltage fluctuation process to monitor the terminal voltage of the system main relay 20.

When the control unit 60 performs the welding check of the system main relay 20, the process proceeds to S205.

### S205

The control unit 60 determines whether welding has occurred in the system main relay 20. The determination is made by the HV-ECU (welding check for SMR function). For example, in a case where the terminal voltages of the system main relay 20 are matched even though the voltage is fluctuated, whether the fixed terminal and the movable terminal (one or both of the plus side and the minus side) are welded can be determined.

When the control unit 60 determines that the welding has not occurred in the system main relay 20 (S205, NO), the process proceeds to S206.

On the other hand, in a case where the control unit 60 determines that the welding has occurred in the system main relay 20 (S205, YES), the welding check for SMR ends.

### S206

The control unit 60 determines a result of the determination of the possibility of the auxiliary electric power supply control. The determination of the possibility of the auxiliary electric power supply control is a determination of whether the electric power supply from the high-voltage battery 10 can be started (possible to start) or cannot be started (not possible to start) for a specific auxiliary load (dashboard camera or the like). The determination here is made based on the result of the determination of the possibility of the auxiliary electric power supply control performed before the IGB-OFF by the auxiliary electric power supply control in S203. The result of the determination of the possibility of the auxiliary electric power supply control is received by the HV-ECU (system control) from the extended body ECU (auxiliary electric power supply control function) after the state of the auxiliary electric power supply control is temporarily stopped.

When the control unit 60 determines that the result of the determination of the possibility of the auxiliary electric power supply control is possible to start (S206, possible to start), the process proceeds to S208.

On the other hand, in a case where the control unit 60 determines that the result of the determination of the possibility of the auxiliary electric power supply control is not possible to start (S206, NOT POSSIBLE TO START), the welding check for SMR ends. In this case, the extended body ECU (auxiliary electric power supply control function) maintains the request for “IGB-OFF by the auxiliary electric power supply control” to the extended body ECU (IGSW control function), and the CAN communication is set to the sleep-permitted state. In addition, “request for the auxiliary power supply control is present” indicated before the IGB-OFF by the auxiliary electric power supply control is discarded.

Alternatively, when the control unit 60 determines that the result of the determination of the possibility of the auxiliary electric power supply control is not received (S206, NOT RECEIVED), the process proceeds to S207.

### S207

The control unit 60 determines whether the first time has elapsed after the IGB-OFF by the auxiliary electric power supply control in S203 is performed. The determination is made to decide whether to maintain the auxiliary electric power supply control that is temporarily stopped in the same state when the result of the determination of the possibility of the auxiliary electric power supply control is not received. The first time can be optionally set, and can be set to, for example, 35 seconds.

When the control unit 60 determines that the first time has elapsed after the IGB-OFF by the auxiliary electric power supply control is performed (S207, YES), the welding check for SMR ends. In this case, the extended body ECU (auxiliary electric power supply control function) maintains the request for “IGB-OFF by the auxiliary electric power supply control” to the extended body ECU (IGSW control function), and the CAN communication is set to the sleep-permitted state. In addition, “request for the auxiliary power supply control is present” indicated before the IGB-OFF by the auxiliary electric power supply control is discarded. Further, the auxiliary electric power supply control to the specific auxiliary load is prohibited until the next Ready-ON.

On the other hand, in a case where the control unit 60 determines that the first time has not elapsed after the IGB-OFF by the auxiliary electric power supply control is performed (S207, NO), the process proceeds to S206.

### S208

The control unit 60 determines whether the request for IGB-ON by other factors is present. The request for IGB-ON by the other factors refers to a request for IGB-ON for the auxiliary electric power supply control by the auxiliary load other than the specific auxiliary load (for example, air conditioning, a battery, and charging) instead of the request for IGB-ON for the auxiliary electric power supply control by the specific auxiliary load. The request for IGB-ON by the other factors is received by the extended body ECU (IGSW control function).

When the control unit 60 determines that the request for IGB-ON by the other factors is present (S208, YES), the process proceeds to S209.

On the other hand, when the control unit 60 determines that the request for IGB-ON by the other factors is not present (S208, NO), the process proceeds to S210.

### S209

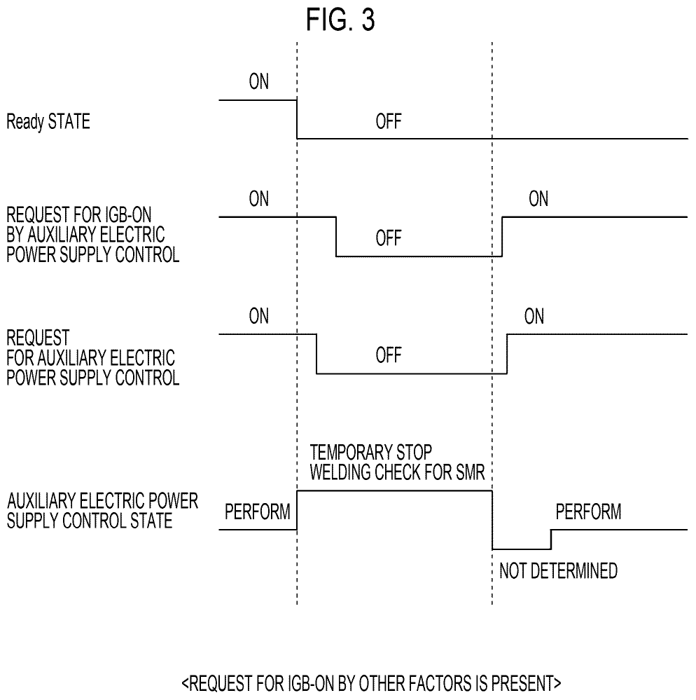

The control unit 60 determines whether it has detected that the state of the auxiliary electric power supply control is undetermined. The auxiliary electric power supply control state=undetermined can be received by the extended body ECU (auxiliary electric power supply control function) from the HV-ECU (system control function) after the state of the auxiliary electric power supply control is temporarily stopped. FIG. 3 is a timing chart illustrating states of each control or request in a case where there is a request for IGB-ON by other factors.

In a case where the control unit 60 detected that the state of the auxiliary electric power supply control is not determined (S209, YES), the process proceeds to S211. On the other hand, in a case where the control unit 60 did not detect that the state of the auxiliary electric power supply control is not determined (S209, NO), the welding check for SMR ends.

### S210

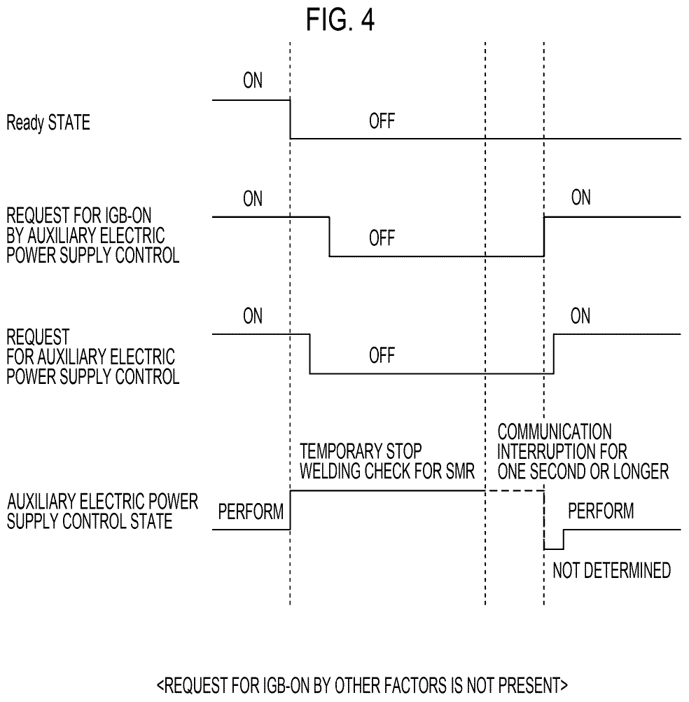

The control unit 60 determines whether the CAN communication between the extended body ECU and the HV-ECU is interrupted for a second time or longer. The second time is set to any time needed to determine the communication interruption, and can be set to, for example, one second. FIG. 4 is a timing chart illustrating states of each control and request in a case where the request for IGB-ON by the other factors is not present.

In a case where the control unit 60 detected that the communication interruption between the extended body ECU and the HV-ECU for the second time or longer (S210, YES), the process proceeds to S211.

On the other hand, in a case where the control unit 60 did not detect the communication interruption between the extended body ECU and the HV-ECU for the second time or longer (S210, NO), the welding check for SMR ends.

### S211

The control unit 60 executes the process of the IGB-ON by the auxiliary electric power supply control. As a specific example of the process, a process can be illustrated in which the extended body ECU (auxiliary electric power supply control function) transmits a request for “IGB-ON by auxiliary electric power supply control” to the extended body ECU (IGSW control function).

When the control unit 60 performs the process of the IGB-ON by the auxiliary electric power supply control, the process proceeds to S212.

### S212

The control unit 60 executes a process of restoring the state of the auxiliary electric power supply control from the temporary stop. A specific example of the process can be a process in which the extended body ECU (auxiliary electric power supply control function) restores (request ON) “request for auxiliary electric power supply control” that is the result of the determination of the possibility of the auxiliary electric power supply control before the IGB-OFF by the auxiliary electric power supply control is performed.

When the control unit 60 executes the process of restoring the state of the auxiliary electric power supply control from the temporary stop, the process proceeds to S213.

### S213

The control unit 60 executes the auxiliary electric power supply control of supplying the electric power of the high-voltage battery 10 to the auxiliary battery 40, the auxiliary load 51, and the auxiliary load 52 via the system main relay 20 and the DCDC converter 30. The control is executed by an extended body ECU (an auxiliary electric power supply control function).

When the control unit 60 executes the auxiliary electric power supply control, the welding check for SMR ends.

### Action and Effect

As described above, with the welding check method for a system main relay according to the embodiment of the present disclosure, whether the system main relay 20 provided between the high-voltage battery 10 mounted on the vehicle and the one or more auxiliary loads 51, 52 is welded may be determined. In this case, the electric power supply from the high-voltage battery 10 to the auxiliary loads 51, 52 is temporarily stopped after the Ready-OFF of the vehicle, and then the welding check of the system main relay 20 is performed. Then, in a case where the result of the welding check is no welding of the system main relay 20, the electric power supply to the auxiliary loads 51, 52 is promptly restarted in response to the request.

According to the method, it is possible to suppress the drain of the auxiliary battery 40 while the welding check of the system main relay 20 is being performed after the Ready-OFF of the vehicle.

Although the embodiment of the present disclosure has been described above, the present disclosure can be regarded as a welding check method for a system main relay, a control unit that executes the method, a program that causes a computer to execute the method, a computer-readable non-transitory recording medium that stores the program, a vehicle equipped with the control unit, and the like.

The method according to the present disclosure can be used in a case where the drain of the auxiliary battery is to be suppressed when the welding check of the system main relay is performed.

What is claimed is:

1. A welding check method for a system main relay provided between a high-voltage battery and one or more auxiliary loads that are mounted on a vehicle, the welding check method comprising:
stopping electric power supply from the high-voltage battery to the auxiliary load after the vehicle is in a Ready-OFF state;
performing a welding check of the system main relay after the electric power supply to the auxiliary load is stopped; and
starting the electric power supply from the high-voltage battery to the auxiliary load in response to a request from the auxiliary load when a result of the welding check indicates that the system main relay is not welded.

2. The welding check method according to claim 1, wherein the stopping the electric power supply to the auxiliary load is stopping the electric power supply from the high-voltage battery to the auxiliary load when the welding check of the system main relay is not able to be continuously performed for a predetermined period due to operation of a specific auxiliary load after the vehicle is in the Ready-OFF state.

3. The welding check method according to claim 2, wherein the specific auxiliary load is a dashboard camera that activates a parking monitoring function after the vehicle is in the Ready-OFF state.
